(19) United States
(12) Patent Application Publication
(10) Pub. No.: US 2013/0111988 A1
(43) Pub. Date: May 9, 2013

(54) Water Well Gauge

(71) Applicant: Thomas W. NEWTON, Midlothian, VA (US)

(72) Inventor: Thomas W. NEWTON, Midlothian, VA (US)

(21) Appl. No.: 13/669,239

(22) Filed: Nov. 5, 2012

Related U.S. Application Data
(60) Provisional application No. 61/555,215, filed on Nov. 3, 2011.

(51) Int. Cl. G01F 23/76

(52) U.S. Cl. 73/293

(57) ABSTRACT

The present invention is a well gauge used to indicate the relative depth of water inside a shallow well. Specifically, the present invention is water well gauge with a calibrated pipe, which visually displays various quantities of water within the well. The calibrated pipe or the floating shaft of the present invention is to be floated perpendicularly to water surface within the well. The shaft is supported by a group of buoys, which floats in line with the water in the well. The buoys are positioned radially around and perpendicularly to the shaft. The present invention further comprises a collar which helps position the shaft vertically and perpendicularly to the water level. The calibrated pipe of the present invention can be read in the absence of light due to an attachment of a solar light-emitting diode (LED). With the present invention installed, water user can regulate water more effectively.

The current application is a nonprovisional application and claims a priority to the U.S. provisional patent application Ser. No. 61/555,215 filed on Nov. 3, 2011. The current application is filed on Nov. 5, 2012 while Nov. 3, 2012 was on a weekend.

### FIELD OF THE INVENTION

The present invention relates generally to a gauge for shallow water wells. More specifically, the gauge is installed on the well cover to indicate the level of the available water within the well.

### BACKGROUND OF THE INVENTION

Currently, there is no convenient apparatus or effective method to determine the amount of water remaining in a surface well. Typically, a well user removes the heavy cement well cover and shines a light to visually estimate the amount of water in the well. This traditional method of estimating the water level within the well is not only difficult and time-consuming, but the method is also prone to inaccuracy. Generally, it is important to monitor levels of water, which is an essential and valuable commodity. It is therefore the object of the present invention to provide a simple way to visually gauge the amount of water remaining in a surface well. Essentially, the present invention is a buoy system with a calibrated pipe, which traverses through the well cover while the buoy system floats on the water inside the well. The height of the water within the well is indicated by the height of the calibrated pipe, which is easily visible above the well cover for the water user to notice.

### BRIEF DESCRIPTION OF THE DRAWINGS

FIG. 1 is a perspective view of the preferred embodiment of the present invention.

FIG. 2 is a transparent perspective view of the preferred embodiment of the present invention.

FIG. 3 is a transparent lateral view of the preferred embodiment of the present invention.

FIG. 4 is a top view of the preferred embodiment of the present invention.

FIG. 5 is a bottom view of the preferred embodiment of the present invention.

### DETAILED DESCRIPTION OF THE INVENTION

All illustrations of the drawings are for the purpose of describing selected versions of the present invention and are not intended to limit the scope of the present invention.

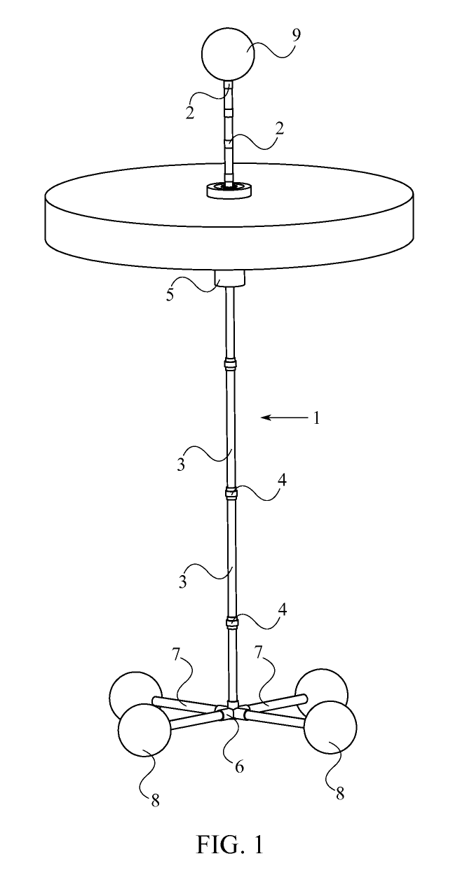

The present invention is a water well gauge, which is a floating gauge that measures the water level within a well limited to 85 feet. The floating gauge helps the user determine the amount of water in a surface well. The present invention visually indicates the amount of water remaining in the surface well. Furthermore, the present invention helps water users to regulate water usage more effectively. Currently, there is no existing or similar device that serves this purpose. The present invention is utilized in conjunction with a well cover, which is constructed from concrete or any composite construction material. As shown in FIG. 1, the present invention comprises a floating shaft 1, a collar 5, a buoy coupler 6, a plurality of buoy pipes 7, a plurality of buoys 8, and a lighted buoy 9. As shown in FIG. 1 to FIG. 3, the floating shaft 1 of the present invention comprises a plurality of shaft pipes 3, a plurality of shaft couplers 4, and a plurality of calibration marks 2. Specifically, each of the plurality of shaft pipes 3 is longitudinally attached to each other via each of the plurality of shaft couplers 4. More specifically, each of the plurality of shaft couplers 4 is attached to a junction whereat each of the plurality of shaft pipes 3 is attached to each other. Each of the plurality of shaft couplers 4 joins each of the plurality of shaft pipes 3 to each other in an adjacently longitudinal manner. Therefore, each of the plurality of shaft couplers 4 is located in between each of the plurality of shaft pipes 3. In the preferred embodiment, the attachment mechanism connecting each of the plurality of shaft pipes 3 to each of the plurality of shaft couplers 4 is polyvinyl chloride (PVC) cement. The floating shaft 1 of the present invention is to be floated perpendicularly to the water surface within the well.

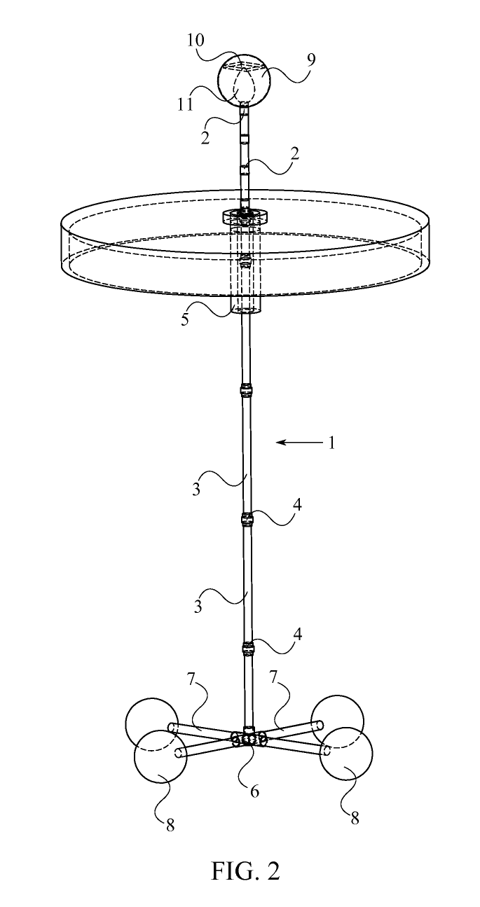

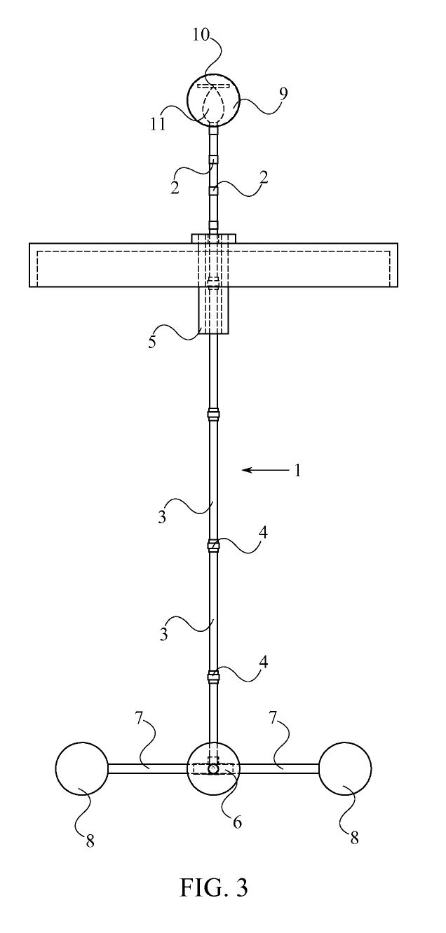

As illustrated in FIG. 1, the lighted buoy 9 is connected atop to the floating shaft 1. Specifically, the lighted buoy 9 is connected to the top of the floating shaft 1 opposite to the buoy coupler 6. In the preferred embodiment, the diameter of the lighted buoy 9 is at least 15 times larger than the diameter of the collar 5 so falling elements such as rain are prevented from entering the well. As shown in FIG. 2 and FIG. 3, the lighted buoy 9 comprises a solar panel 10 and an illumination source 11. The illumination source 11 is operatively coupled to the solar panel 10 so the illumination source 11 may be lit up above the plurality of calibration marks 2 for the observer to read the plurality of calibration marks 2 in the absence of light. The solar panel 10 serves as a power supply to the illumination source 11. Specifically, the solar panel 10 serves as a voltaic cell, which converts solar energy into electricity to power the one illumination source. Essentially, the illumination source 11 serves as a light powered by solar energy provided from the solar panel 10. The illumination source 11 is a low-voltage light source such as a light-emitting diode (LED) and an organic light-emitting diode (OLED). In the preferred embodiment, both the illumination source 11 and the solar panel 10 are located inside the lighted buoy 9. Specifically, the illumination source 11 is located under the solar panel 10 so the solar panel 10 may capture solar energy effectively and relay the energy down to the illumination source 11.

As the top end of the floating shaft 1 traverses centrally into the lighted buoy 9, the midsection of the floating shaft 1 traverses vertically and concentrically through the collar 5 as shown in FIG. 1. After traversing through the collar 5, a bottom end of the floating shaft 1 is connected to the buoy coupler 6 via threading. Therefore, the collar 5 is positioned between the buoy coupler 6 and the lighted buoy 9. The collar 5 has a length of 1 foot. The collar 5 of the present invention serves as a stabilizing structure to reinforce the longitudinal architecture of the floating shaft 1. With the collar 5, the floating shaft 1 is able to maintain its vertical position while the entire water well gauge moves and up correspondingly to the varying water level within the well. Specifically, the collar 5 is a cylinder with a hole traversing centrally through and along the length of the cylinder. The hole of the cylinder or the collar 5 is wherethrough the floating shaft 1 traverses. With the floating shaft 1 positioned within the hole thereof, the longitudinal configuration of the floating shaft 1 is reinforced and protected. As illustrated in FIG. 1 and FIG. 2, the body of the collar 5 traverses centrally through a pre-drilled hole of the well cover and is firmly attached thereto. The pre-drilled hole is located centrally on the well cover and is either ½ or ¾ of an inch in diameter in preferred embodiment. In order for the collar 5 to stay attached to the well cover, the collar 5 further comprises a stopper flange which is positioned atop the collar 5. The cylinder hole also traverses centrally through the stopper flange. Therefore, the floating shaft 1 also traverses concentrically through the stopper flange. The stopper flange helps the apparatus to be held in place by the well cover. The stopper flange is a circular flange centrally connected to the circular cross section of the top end of the collar 5. The stopper flange stabilizes the body of the collar 5 and prevents the body of the collar 5 from slipping into the well. Furthermore, the stopper flange allows the user to easily remove the collar 5 and thus the entire apparatus from the well cover for maintenance and repairs.

Along with the plurality of shaft couplers 4, there is the plurality of calibration marks 2 located sequentially below the lighted buoy 9. The plurality of calibration marks 2 visually displays the amount of water within the well at various capacities. Each of the plurality of calibration marks 2 indicates a different water level within the well. As illustrated in FIG. 1, FIG. 2, and FIG. 3, the plurality of calibration marks 2 is linearly distributed along the floating shaft 1 and positioned below the lighted buoy 9. More specifically, the plurality of calibration marks 2 is positioned between the buoy coupler 6 and the lighted buoy 9, but in closer proximity to the lighted buoy 9. Each of the plurality of calibration marks 2 indicates a different position of the water level within the well. Therefore, as the water inside the well recedes, the floating shaft 1 is lowered into the well; as the water inside the well rises, the floating shaft 1 elevates. In the preferred embodiment, each of the plurality of calibration marks 2 is color coded. For example, the lowest calibration mark on the floating shaft 1 is green, which indicates fully capacity. As the water level within the well rises close to the top of the well, the lowest calibration mark is elevated out of the well to be clearly visible to the water user. Above the lowest calibration mark is a yellow calibration mark, which indicates a 75 percent capacity. If the yellow water marking was visible above the collar 5, the user could infer the well is approximately 75 percent full. Similarly, a blue calibration mark above the yellow calibration mark indicates a 25 percent capacity. The last calibration mark is of the color red, which indicates an empty well. The red calibration mark should be near the top of the floating shaft 1, next to the lighted buoy 9.

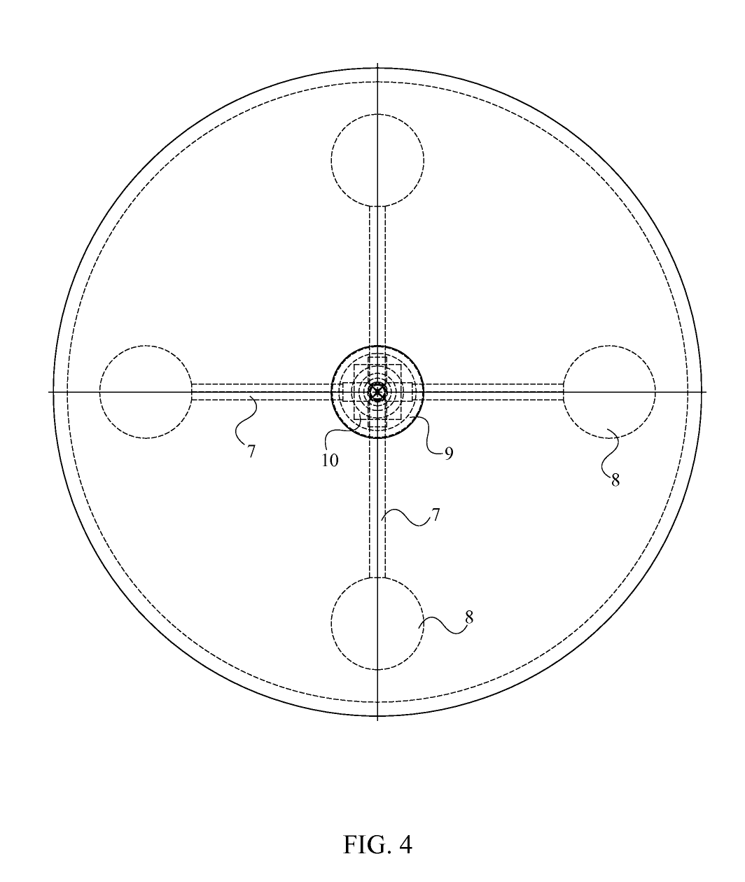

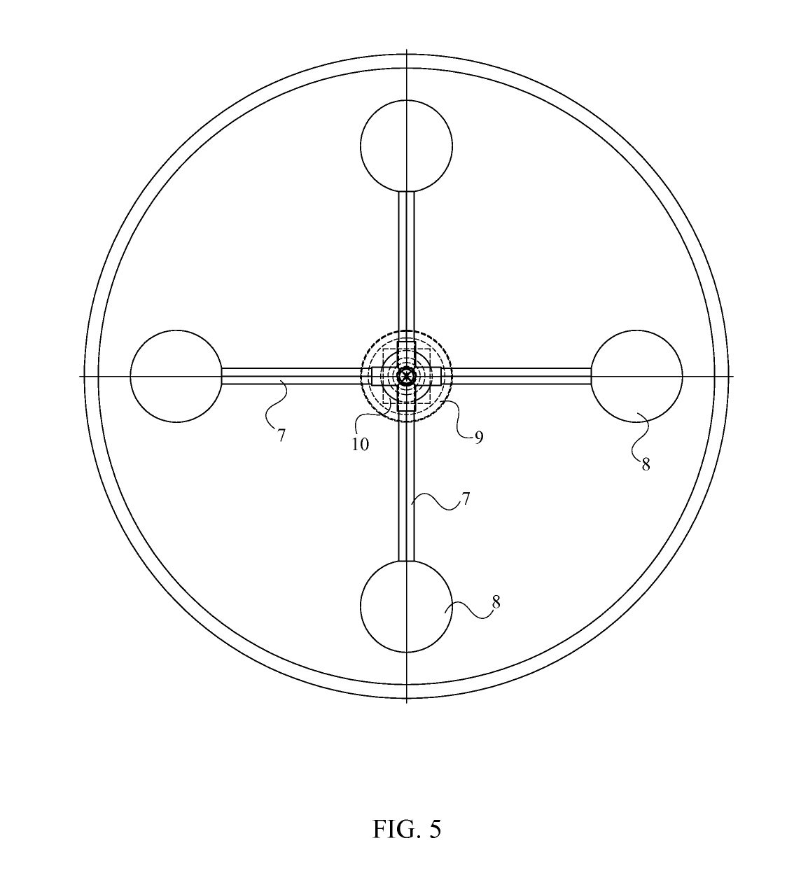

As attached to the floating shaft 1, but opposite to the lighted buoy 9 is the buoy coupler 6. Specifically, the buoy coupler 6 is attached to the bottom end of the floating shaft 1 while the lighted buoy 9 is attached to the top end of the floating shaft 1 as shown in FIG. 1. Essentially, the buoy coupler 6 and the lighted buoy 9 are positioned at opposite ends along the floating shaft 1 as shown in FIG. 1, FIG. 2, and FIG. 3. The buoy coupler 6 serves to attach the plurality of buoys 8 to the bottom of the floating shaft 1 so the floating shaft 1 may be floated on the water level within the well. Each of the plurality of buoys 8 is attached to the buoy coupler 6 via each of the plurality of buoy pipes 7. The plurality of buoy pipes 7 serves as connectors connecting the plurality of buoys 8 to the buoy coupler 6 and the floating shaft 1 as shown in FIG. 1 and FIG. 5. Specifically, each of the plurality of buoys 8 is attached to the distal end of each of the plurality of buoy pipes 7. Moreover, each of the plurality of buoys 8 is attached to each of the plurality of buoy pipes 7 by a threading mechanism. The distal end of each of the plurality of buoy pipes 7 is in proximity with the circumferential wall of the well whereas the proximal end of each of the plurality of buoy pipes 7 is attached to the buoy coupler 6. Each of the plurality of buoy pipes 7 is attached to the buoy coupler 6 also by a threading mechanism. As the proximal end of each of the plurality of buoy pipes 7 is attached to the buoy coupler 6, which is positioned centrally below the collar 5 and within the well, each of the plurality of buoy pipes 7 radiates outward from the buoy coupler 6 to within 5 inches short of the circumferential wall of the well as shown in FIG. 4 and FIG. 5. Therefore, the plurality of buoy pipes 7 is radially positioned around the buoy coupler 6. In the preferred embodiment, the plurality of buoy pipes 7 is made of a durable and buoyant material such as polyvinyl chloride (PVC). In the present invention, the plurality of buoy pipes 7 is required to be made of a strong yet buoyant material to endure the oscillatory changes of water level within the well.

Once attached to the buoy coupler 6, each of the plurality of buoys 8 is attached to the distal end of each of the plurality of buoy pipes 7. Therefore, the plurality of buoys 8 is also radially positioned around the buoy coupler 6 and the plurality of buoy pipes 7 as shown in FIG. 4 and FIG. 5. Specifically, the plurality of buoys 8 is positioned between the plurality of buoy pipes 7 and the circumferential wall of the well. Specifically, each of the plurality of pipes is 5 inches short of the circumferential wall of the well as illustrated in FIG. 4 and FIG. 5. The plurality of buoys 8 floats and stabilizes the apparatus within the well. As the water level within the well changes, the plurality of buoys 8 will move up or down to reflect the change in the water level. In the preferred embodiment, the present invention comprises an X-coupler, four pipes, and four buoys. It is understood that the buoy coupler 6 could be of any configuration. The X-coupler serves as the buoy coupler 6 of the present invention in the preferred embodiment. The X-coupler comprises four pipe holes arranged coplanarly yet perpendicularly from each other in an X configuration. Erecting perpendicularly and centrally from the plane of the four pipe holes is a fifth pipe hole. The fifth pipe hole is attached to the bottom end of the floating shaft 1 with the four pipe holes perpendicularly and radially positioned from the floating shaft 1 as illustrated in FIG. 1 and FIG. 5. Specifically, the four pipe holes of the X-coupler are equidistantly arranged in a circular configuration, 5 inches short of the well wall. Other embodiments of the present invention may comprise a buoy coupler 6 composed of more or less than four pipe holes arranged coplanarly and radially. The more pipe holes radiate from the fifth pipe hole or the main pipe hole, the higher the stability of the buoy coupler 6. Attached to each of four pipe holes of the buoy coupler 6 is each of the plurality of buoy pipes 7, which is attached to a spherical buoy. In the present invention, the plurality of buoy pipes 7 may be attached to the buoy coupler 6 through a threading mechanism. The plurality of buoys 8 may be composed of any buoyant material. In the preferred embodiment, the plurality of buoys 8 is positioned 5 inches away from the circumferential wall of the well.

In the preferred embodiment, the floating shaft 1 may be comprised of a bundle of seventeen five foot shaft pipes arranged longitudinally. The floating shaft 1 traverses concentrically through the collar 5 in an 80 foot well. The bundle of seventeen five foot shaft pipes are connected to each other by each of the plurality of shaft couplers 4. The bundle of seventeen five foot shaft pipes is connected to seventeen couplers with one spare for the 80 foot well. In this embodiment, one tube of PVC cement is used. Four buoys are used with a top buoy containing a solar LED light whereas the lower buoys are positioned 5 inches away from the circumferential wall of the well. The 5 inch distance between the plurality of buoys and the wall of the well is constant and independent of the diameter of the well. The seventeen five foot shaft pipes are calibrated and positioned vertically to extend out of the top of the well. The calibrated pipe or the floating shaft 1 of the present invention determines the depth of the water in the well. The collar 5 prevents the calibrated pipe or the floating shaft 1 from tipping and maintains the plurality of buoys 8 and the floating shaft 1 or the calibrated pipe in an upright position while preventing inaccurate readings. The collar 5 also prevents rainwater or any other material from entering into the well.

Once installed, the well cover keeps the apparatus in place and reading accurately. Thus, no post-installation action(s) is required. All components come in a kit which the well contractor purchases and then assembles on site. The components consist mainly of PVC material held together by PVC cement. If the present invention is put into a new well, the apparatus can simply be installed when building the well. If the present invention is put into an existing well, a hole must be drilled into the concrete well cover to insert the present invention. In the preferred embodiment, the lighted buoy 9 is pre-assembled with the solar LED to provide visibility for the floating shaft 1 and the plurality of calibration marks 2 at night or during foggy days.

The present invention includes a calibration method thereof. The calibration method is initiated by the user removing a cement cover of a well and lowering a floating shaft 1 to a bottom of the well. Then, the user wraps a red tape around the floating shaft 1 at the level of the well cover to indicate an empty well. In a well with a full capacity, the user attaches a buoy coupler 6, a plurality of buoy pipes 7, and a plurality of buoys 8 to a bottom end of the floating shaft 1. Specifically, the user attaches the buoy coupler 6 to the bottom end of the floating shaft 1. Subsequently, the user attaches each of the plurality of buoy pipes 7 to each of a plurality of pipe holes located on the buoy coupler 6. Then, the user attaches each of the plurality of buoys 8 to each of the plurality of buoy pipes 7. Particularly, the user attaches each of the plurality of buoys 8 to a distal end of each of the plurality of buoy pipes 7, whereas a proximal end of each of the plurality of buoy pipes 7 is attached to the buoy coupler 6. Once the plurality of buoy pipes 7 and the plurality of buoys 8 float upon the water, the user wraps a green tape around the floating shaft 1 and a plurality of calibration marks 2 to the floating shaft 1 at the level above the collar 5. Specifically, the user may mark a green tape to indicate full capacity. Then, using individual preference, the user wraps a yellow tape and a blue tape equidistant between the green tape and the red tape. Respectively, the yellow tape indicates 75 percent capacity whereas the blue tape indicates 25 percent capacity. Once the plurality of buoys 8 and the plurality of calibration marks 2 are attached to the apparatus, the plurality of buoys 8 rises and lowers with the water level and thus the plurality of buoys 8 moves the floating shaft 1 and consequently apparatus up or down. The collar 5 of the apparatus fits to 1/16 of an inch; therefore, the entry of rainwater and other materials would be negligible.

Although the invention has been explained in relation to its preferred embodiment, it is to be understood that many other possible modifications and variations can be made without departing from the spirit and scope of the invention as hereinafter claimed.

What is claimed is:

1. A water well gauge comprises,
a floating shaft;
a collar;
a buoy coupler;
a plurality of buoy pipes;
a plurality of buoys;
a lighted buoy;
the floating shaft comprising a plurality of calibration marks, a plurality of shaft pipes, and a plurality of shaft couplers; and
the lighted buoy comprising a solar panel and an illumination source.

2. The water well gauge as claimed in claim 1 comprises,
the floating shaft traversing concentrically through the collar;
the floating shaft traversing vertically through the collar;
the floating shaft being connected to the buoy coupler;
the floating shaft being connected to the lighted buoy;
the collar being positioned between the buoy coupler and the lighted buoy;
each of the plurality of shaft pipes being attached to each other longitudinally; and
each of the plurality of shaft pipes being attached to each other via each of the plurality of shaft couplers.

3. The water well gauge as claimed in claim 1 comprises;
the plurality of buoy pipes being attached to the buoy coupler;
the plurality of buoys being attached to the plurality of buoy pipes; and
each of the plurality of buoys being attached to each of the plurality of buoy pipes.

4. The water well gauge as claimed in claim 3 comprises,
the plurality of buoy pipes being radially positioned around the buoy coupler; and
the plurality of buoys being radially positioned around the buoy coupler.

5. The water well gauge as claimed in claim 1 comprises,
the lighted buoy being connected to the floating shaft opposite to the buoy coupler; and
the illumination source being operatively coupled to the solar panel.

6. The water well gauge as claimed in claim 1 comprises,
the plurality of calibration marks being linearly distributed along the floating shaft;
the plurality of calibration marks being positioned adjacent to the lighted buoy; and
the plurality of calibration marks being positioned between the buoy coupler and the lighted buoy.

7. A water well gauge comprises,
a floating shaft;
a collar;
a buoy coupler;
a plurality of buoy pipes;
a plurality of buoys;
a lighted buoy;
the floating shaft comprising a plurality of calibration marks, a plurality of shaft pipes, and a plurality of shaft couplers;
the lighted buoy comprising a solar panel and an illumination source;
the floating shaft traversing concentrically through the collar;
the floating shaft traversing vertically through the collar;
the floating shaft being connected to the buoy coupler;
the floating shaft being connected to the lighted buoy;
the collar being positioned between the buoy coupler and the lighted buoy;
each of the plurality of shaft pipes being attached to each other longitudinally; and
each of the plurality of shaft pipes being attached to each other via each of the plurality of shaft couplers.

8. The water well gauge as claimed in claim 7 comprises;
the plurality of buoy pipes being attached to the buoy coupler;
the plurality of buoys being attached to the plurality of buoy pipes; and
each of the plurality of buoys being attached to each of the plurality of buoy pipes.

9. The water well gauge as claimed in claim 8 comprises,
the plurality of buoy pipes being radially positioned around the buoy coupler; and
the plurality of buoys being radially positioned around the buoy coupler.

10. The water well gauge as claimed in claim 7 comprises,
the lighted buoy being connected to the floating shaft opposite to the buoy coupler; and
the illumination source being operatively coupled to the solar panel.

11. The water well gauge as claimed in claim 7 comprises,
the plurality of calibration marks being linearly distributed along the floating shaft;
the plurality of calibration marks being positioned adjacent to the lighted buoy; and
the plurality of calibration marks being positioned between the buoy coupler and the lighted buoy.

12. A water well gauge comprises,
a floating shaft;
a collar;
a buoy coupler;
a plurality of buoy pipes;
a plurality of buoys;
a lighted buoy;
the floating shaft comprising a plurality of calibration marks, a plurality of shaft pipes, and a plurality of shaft couplers;
the lighted buoy comprising a solar panel and an illumination source;
the floating shaft traversing concentrically through the collar;
the floating shaft traversing vertically through the collar;
the floating shaft being connected to the buoy coupler;
the floating shaft being connected to the lighted buoy;
the collar being positioned between the buoy coupler and the lighted buoy;
each of the plurality of shaft pipes being attached to each other longitudinally;
each of the plurality of shaft pipes being attached to each other via each of the plurality of shaft couplers;
the plurality of buoy pipes being attached to the buoy coupler;
the plurality of buoys being attached to the plurality of buoy pipes; and
each of the plurality of buoys being attached to each of the plurality of buoy pipes.

13. The water well gauge as claimed in claim 12 comprises,
the plurality of buoy pipes being radially positioned around the buoy coupler; and
the plurality of buoys being radially positioned around the buoy coupler.

14. The water well gauge as claimed in claim 12 comprises,
the lighted buoy being connected to the floating shaft opposite to the buoy coupler; and
the illumination source being operatively coupled to the solar panel.

15. The water well gauge as claimed in claim 12 comprises,
the plurality of calibration marks being linearly distributed along the floating shaft;
the plurality of calibration marks being positioned adjacent to the lighted buoy; and
the plurality of calibration marks being positioned between the buoy coupler and the lighted buoy.
